(19) United States
(12) Patent Application Publication
(10) Pub. No.: US 2013/0115886 A1
(43) Pub. Date: May 9, 2013

(54) APPARATUS AND METHOD FOR POLARIZATION ALIGNMENT IN A WIRELESS NETWORK

(71) Applicants: Farooq Khan, Allen, TX (US); George Zohn Hutcheson, Richardson, TX (US); Mike Brobston, Allen, TX (US); Zhouyue Pi, Allen, TX (US)

(72) Inventors: Farooq Khan, Allen, TX (US); George Zohn Hutcheson, Richardson, TX (US); Mike Brobston, Allen, TX (US); Zhouyue Pi, Allen, TX (US)

(73) Assignee: Samsung Electronics Co., Ltd., Suwon-si (KR)

(21) Appl. No.: 13/599,795

(22) Filed: Aug. 30, 2012

Related U.S. Application Data
(60) Provisional application No. 61/556,055, filed on Nov. 4, 2011.

(51) Int. Cl. H04B 7/10; H04B 7/08; H04B 7/06

(52) U.S. Cl. 455/42; 455/129; 455/69; 455/113; 455/269; 455/205; 455/39

(57) ABSTRACT

A system is configured to enable polarization alignment. The system includes at least one transmitter or receiver capable of polarization alignment. The transmitter includes at least one cross-polarized antenna and the receiver includes at least one cross-polarized antenna configured to receive a signal. A polarization processor in the transmitter or the receiver is configured to cause a polarization orientation of the at least one cross-polarized antenna to align with a polarization orientation of the signal.

### CROSS-REFERENCE TO RELATED APPLICATION(S) AND CLAIM OF PRIORITY

The present application claims priority to U.S. Provisional Patent Application No. 61/556,055, filed Nov. 4, 2011, entitled “POLARIZATION ALIGNMENT IN A WIRELESS SYSTEM”. The above-identified patent document is hereby incorporated by reference.

### TECHNICAL FIELD

The present application relates generally to wireless communications systems and, more specifically, to a system and method for polarization alignment of wireless signals in a wireless communications system.

### BACKGROUND

Millimeter wave (mmWave) cellular systems have been proposed to accommodate the explosive trends in mobile data demands due to the availability of large bands of spectrum. Millimeter wave's high carrier frequency facilitates packing many antenna elements in small form factors, thus enabling multiple-input multiple-output (MIMO) processing with very large arrays. MIMO antenna systems, also known as multiple-element antenna (MEA) systems, achieve greater spectral efficiency for allocated radio frequency (RF) channel bandwidths by utilizing space or antenna diversity at both the transmitter and the receiver, or in other cases, the transceiver. In MIMO systems, each of a plurality of data streams (or layers) is individually mapped and modulated before being precoded and transmitted by different physical antennas or effective antennas. The combined data streams are then received at multiple antennas of a receiver. At the receiver, each data stream is separated and extracted from the combined signal. This process can be performed, for example, using a maximum likelihood MIMO detection algorithm, or a minimum mean squared error (MMSE) MIMO algorithm.

Beamforming in mmWave systems with large arrays is needed to counteract high path loss with highly directional transmission. Prior mmWave beamforming strategies, however, have made very limited use of MIMO signal processing results for a variety of reasons. For example, MIMO often assumes hardware complexity that is impractical in large arrays, such as a dedicated radio frequency (RF) chain per antenna element.

### SUMMARY

A transmitter capable of polarization alignment is provided. The transmitter includes at least one cross-polarized antenna configured to transmit a signal. The transmitter includes a polarization processor configured to alter a polarization orientation of the signal to align with a polarization orientation of a receiver.

A receiver capable of polarization alignment is provided. The receiver includes at least one cross-polarized antenna configured to receive a signal. The receiver also includes a polarization processor configured to cause a polarization orientation of the at least one cross-polarized antenna to align with a polarization orientation of the signal.

A method for aligning polarization orientation is provided. The method includes aligning, by a polarization processor, a polarization orientation of at least one cross-polarized antenna at a receiver with a polarization orientation of a transmitted signal.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates dynamic beamforming according to embodiments of the present disclosure;

FIG. 2 illustrates a two-dimensional array according to embodiments of the present disclosure;

FIG. 3 illustrates a transmit beamforming according to embodiments of the present disclosure;

FIG. 4 illustrates a receive beamforming according to embodiments of the present disclosure;

FIG. 5 illustrates digital beamforming according to embodiments of the present disclosure;

FIG. 6 illustrates analog beamforming according to embodiments of the present disclosure;

FIG. 7 illustrates Radio Frequency beamforming according to embodiments of the present disclosure;

FIG. 8 illustrates signal polarizations according to embodiments of the present disclosure;

FIG. 9 illustrates cross polarization according to embodiments of the present disclosure;

FIGS. 10 and 11 illustrate Fields (E) generated by respective antenna elements according to embodiments of the present disclosure; and

FIGS. 12 through 16 illustrate systems capable of polarization alignment according to embodiments of the present disclosure.

### DETAILED DESCRIPTION

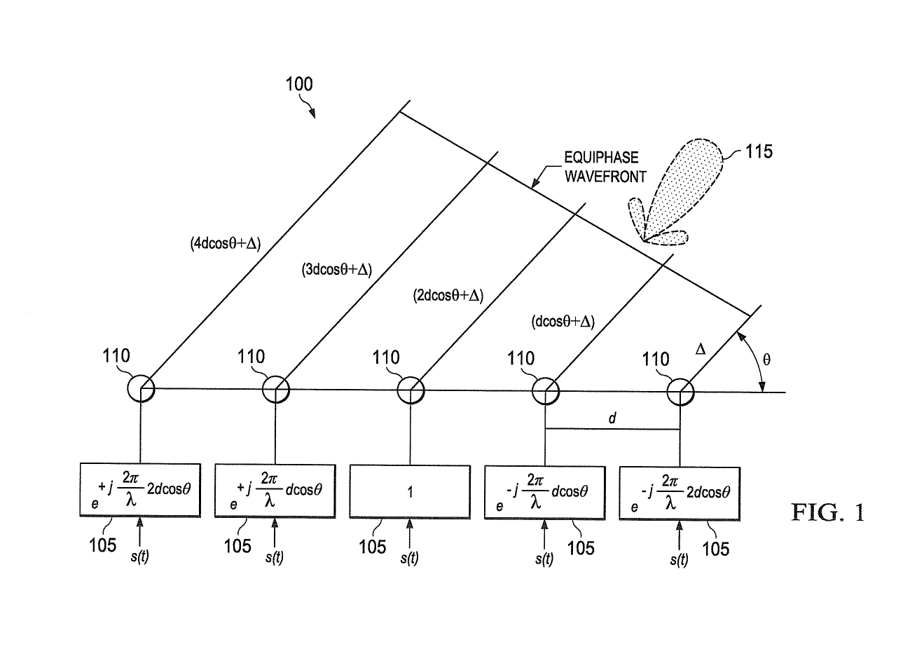

FIGS. 1 through 16, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged wireless communications system.

Beamforming is a technique used for directional signal transmission or reception in a wireless system. The spatial selectivity is achieved by using adaptive receive/transmit beam patterns. When transmitting, a beamformer controls the phase and relative amplitude of the signal at each transmitter antenna to create a pattern of constructive and destructive interference in the wavefront. The receiver combines information from different antennas in such a way that the expected pattern of radiation is preferentially observed. The improvement compared with an omnidirectional reception/transmission is known as the receive/transmit gain. For example, with N transmit antennas, a transmit beamforming gain of 10×log₁₀(N) dB can be achieved. This is assuming that the total transmit power from the N antennas is the same as the transmit power from a single omnidirectional antenna. Similarly, with M receive antennas, a receive beamforming gain of 10×log₁₀(M) dB can be achieved. When both transmit and receive beamforming is performed with N transmit and M receive antennas a total combined beamforming gain of 10×log₁₀(N×M) dB can be achieved.

FIG. 1 illustrates dynamic beamforming according to embodiments of the present disclosure. The embodiment of the dynamic beamforming shown in FIG. 1 is for illustration only. Other embodiments could be used without departing from the scope of this disclosure.

A transceiver 100 with a uniform linear array (ULA) performs dynamic beamforming by adjusting weights 105 that are based on phase control. By using appropriate phase adjustments to signals transmitted (or received) from multiple antennas 110, a beam 115 can be steered in a particular direction.

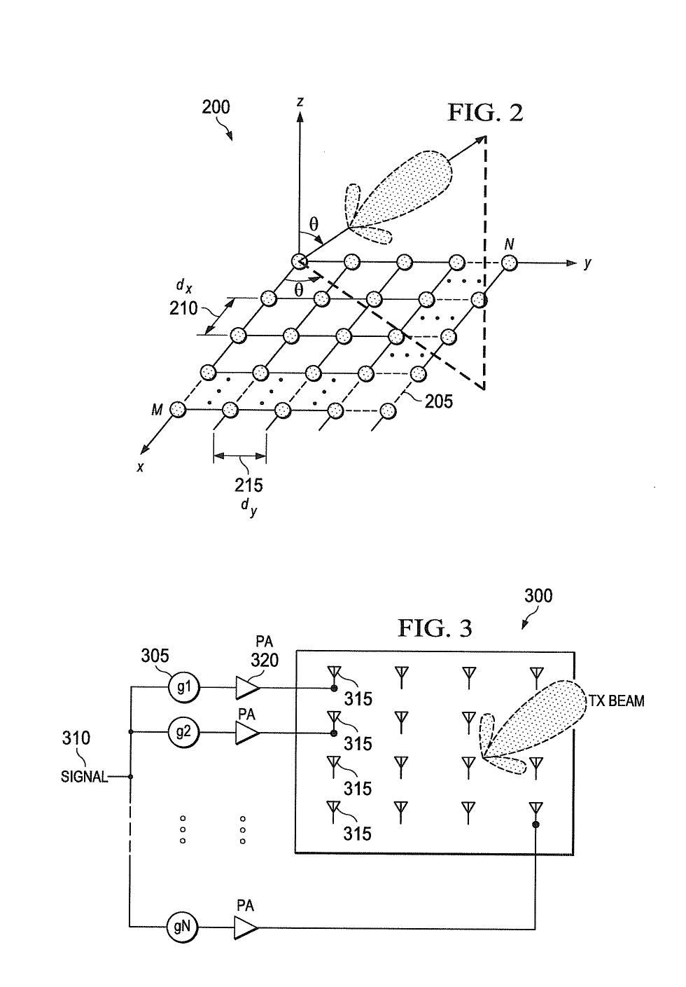

FIG. 2 illustrates a two-dimensional (2D) array according to embodiments of the present disclosure. The embodiment of the 2-D array 200 shown in FIG. 2 is for illustration only. Other embodiments could be used without departing from the scope of this disclosure.

With an ULA, a transmitter can steer a beam in a single plane containing the line of the antenna elements' centers. In order to steer the beam in any direction, such as horizontal and vertical steering from a base station, the transmitter employs a 2-D antenna array 200 as shown. The array grid 205 can have equal or unequal row spacings (dₓ) 210 and column spacings (d_{y}) 215.

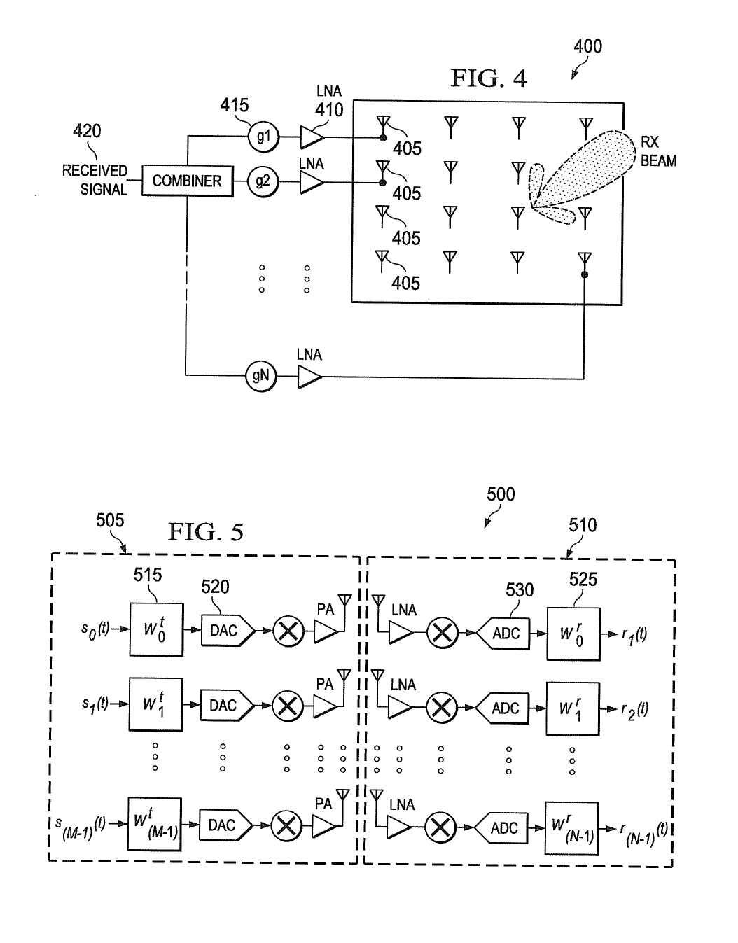

FIG. 3 illustrates a transmit beamforming according to embodiments of the present disclosure. The embodiments of the transmit beamforming 300 shown in FIG. 3 is for illustration only. Other embodiments could be used without departing from the scope of this disclosure.

A transmitter applies a beamforming weight or gain gᵢ 305 to the signal 310 transmitted from the ith transmit antenna. The transmitter applies the gain 305 to adjust the phase and relative amplitude of the signal 310 transmitted from each of the transmit antennas 315. The signal 310 can be amplified 320 separately for transmission from each of the transmit antennas 315. In certain embodiments, a single amplifier 320 is used regardless of the number of transmit antennas 315. In certain embodiments, the transmitter includes a few number of amplifiers 320 than the number of transmit antennas 315. That is a less number of amplifiers 320 than the number of transmit antennas 315 is used. In certain embodiments, the beamforming weights or gains 305 are applied before signal amplification 320. In certain embodiments, the beamforming weights or gains 305 are applied after signal amplification 320.

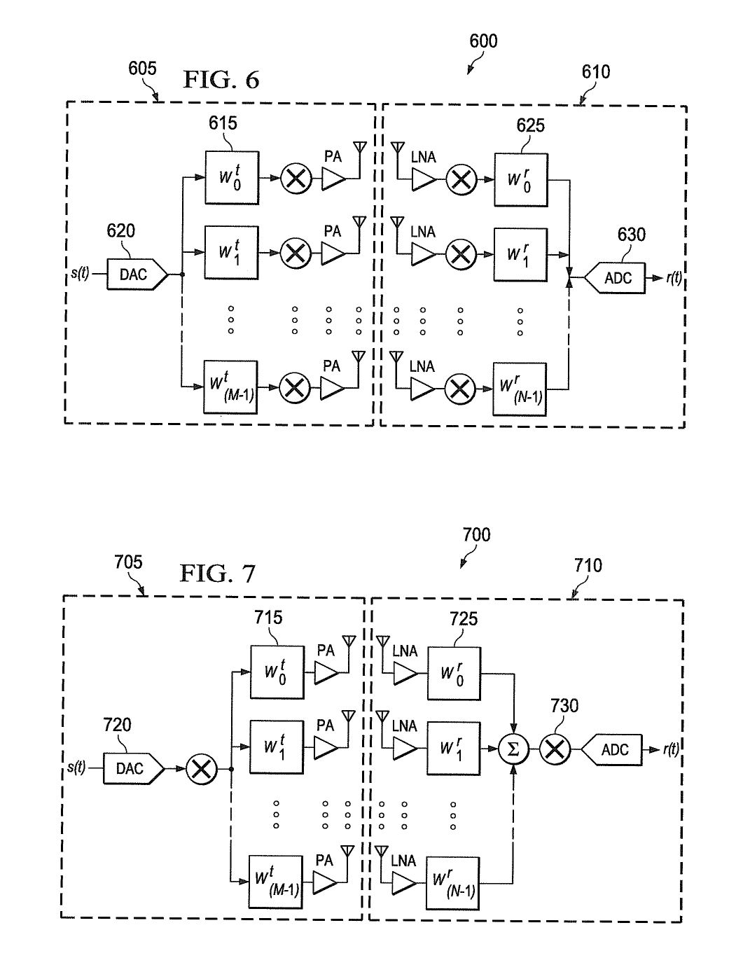

FIG. 4 illustrates a receive beamforming according to embodiments of the present disclosure. The embodiments of the receive beamforming 400 shown in FIG. 4 is for illustration only. Other embodiments could be used without departing from the scope of this disclosure.

Each receive antenna 405 received signal from each receive antenna is amplified by a low-noise amplifier (LNA) 410. The receiver applies a beamforming weight or gain gi 415 to the signal 420 received and amplified signal from the ith receive antenna 405. The receiver uses the gain 415 to adjust the phase and relative amplitude of the signal 420 received from each of the transmit antennas 405. The phase and amplitude adjusted signals are combined to produce the received signal 420. The receive beamforming gain 415 is obtained because of coherent or constructive combining of the signals from each receive antenna.

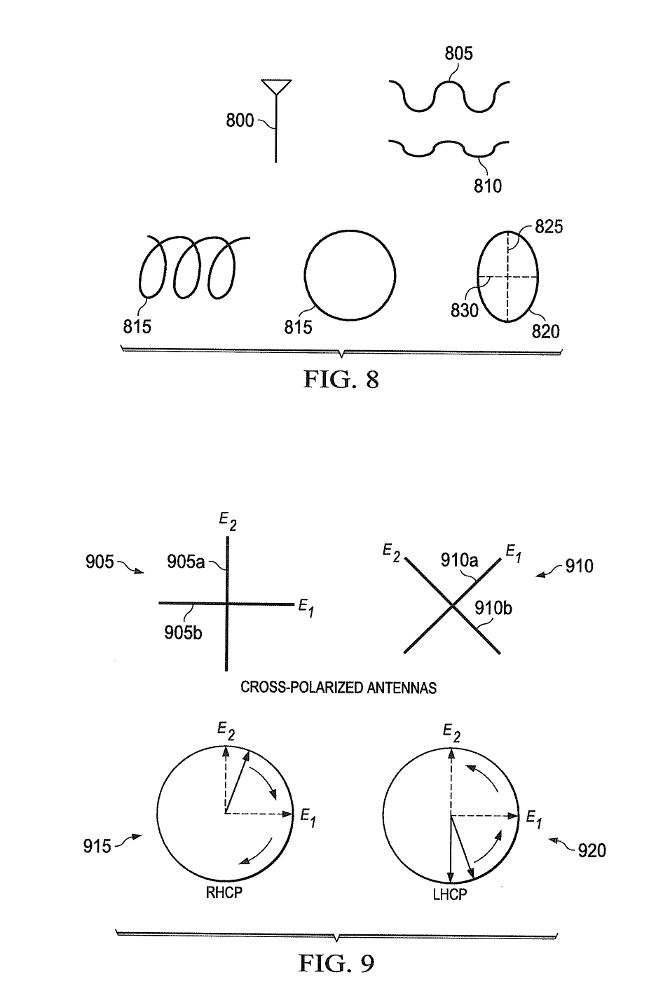

FIG. 5 illustrates digital beamforming according to embodiments of the present disclosure. The embodiment of the digital beamforming 500 shown in FIG. 5 is for illustration only. Other embodiments could be used without departing from the scope of this disclosure.

In the example shown in FIG. 5, a transmitter 505 uses digital beamforming techniques to transmit a signal. A receiver 510 uses corresponding digital beamforming techniques to receive the signal.

Different beamforming architectures that enable different tradeoffs between performance, complexity and flexibility are possible. For example, the digital beamforming approach 500 enables optimal capacity for all channel conditions while requiring very high hardware complexity with M (N) full transceivers. This architecture also results in very high system power consumption. The beamforming weights 515 at the transmitter 505 W₀^{t}-W_{(M-1)}^{t} are applied before signal conversion to analog, that is, before the Digital to Analog (DAC) conversion block 520. The beamforming weights 525 at the receiver 510 W₀^{r}-W_{(M-1)}^{r} are applied after signal is converted to digital using an Analog to Digital (ADC) converter 530.

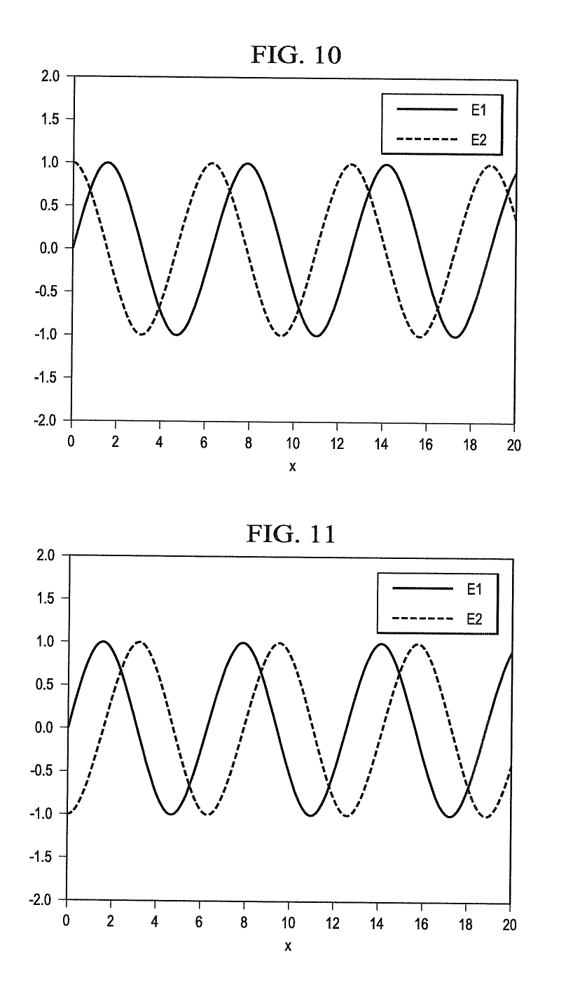

FIG. 6 illustrates analog beamforming according to embodiments of the present disclosure. The embodiment of the analog beamforming 600 shown in FIG. 6 is for illustration only. Other embodiments could be used without departing from the scope of this disclosure.

In the example shown in FIG. 6, a transmitter 605 uses analog beamforming techniques to transmit a signal. A receiver 610 uses corresponding analog beamforming techniques to receive the signal.

Analog baseband beamforming 600 reduces the number of data converters (ADC/DAC) providing intermediate complexity and power consumption while losing some flexibility in beamforming control. The beamforming weights 615 at the transmitter 605 W₀^{t}-W_{(M-1)}^{t} are applied after signal conversion to analog, that is, after the Digital to Analog (DAC) conversion block 620. The beamforming weights 625 at the receiver 610 W₀^{r}-W_{(M-1)}^{r} are applied before signal is converted to digital using an Analog to Digital (ADC) converter 630.

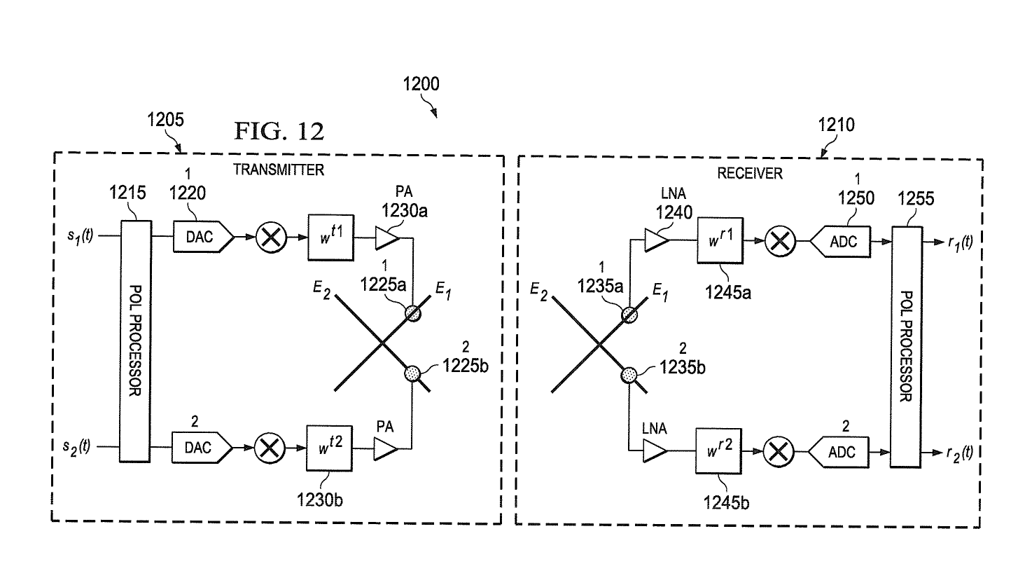

FIG. 7 illustrates Radio Frequency (RF) beamforming according to embodiments of the present disclosure. The embodiment of the RF beamforming 700 shown in FIG. 7 is for illustration only. Other embodiments could be used without departing from the scope of this disclosure.

In the example shown in FIG. 7, a transmitter 705 uses analog beamforming techniques to transmit a signal. A receiver 710 uses corresponding analog beamforming techniques to receive the signal.

The RF beamforming 700 reduces the number mixers required in addition to reducing the number of data converters (ADC/DAC) therefore providing lowest complexity and power consumption. However, this reduction in complexity comes at the expense of reduced flexibility in beamforming control as well as the limited options for multiple access to serve multiple users simultaneously. The beamforming weights 715 at the transmitter 705 W₀^{t}-W_{(M-1)}^{t} are applied after signal up-conversion to RF frequency, that is, after the mixer block 720. The beamforming weights 725 at the receiver 710 W₀^{r}-W_{(M-1)}^{r} are applied before signal is down-converted from RF, that is, before the mixer block 730.

In certain embodiments, other approaches, such as phase and/or amplitude control of the Local Oscillator (LO) signal in conjunction with a LO distribution network, are used for beamforming weights control.

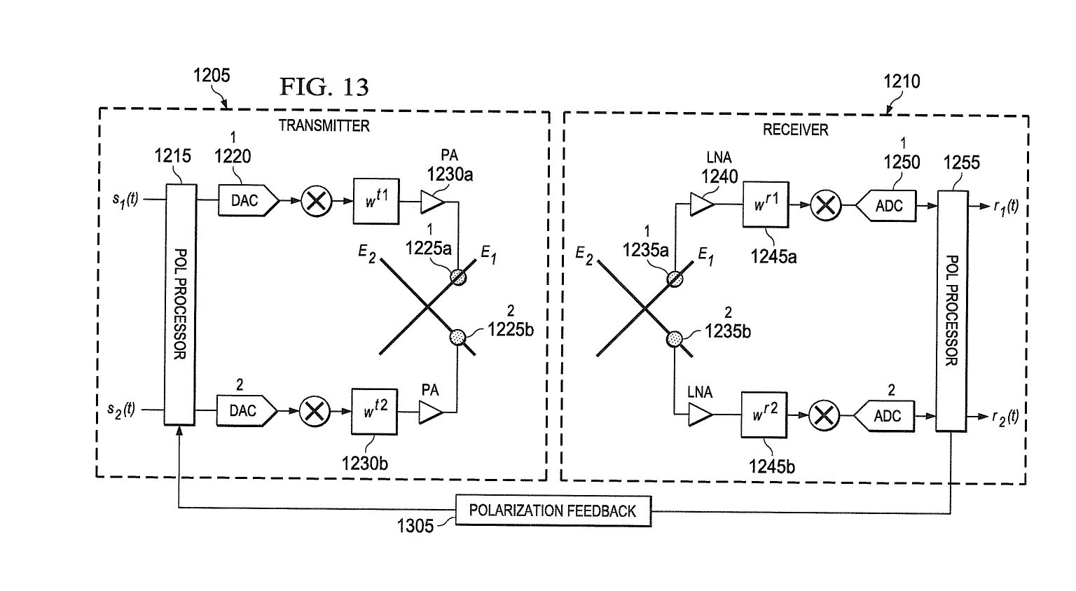

FIG. 8 illustrates signal polarizations according to embodiments of the present disclosure. The embodiments of the signal polarizations 800 shown in FIG. 8 are for illustration only. Other embodiments could be used without departing from the scope of this disclosure.

In this disclosure, polarization is defined from the point of view of the source. The polarization of an antenna is the orientation of the electric field (E-plane) of the radio wave with respect to the Earth's surface and is determined by the physical structure of the antenna and by its orientation. Thus, a simple straight wire antenna 800 will have one polarization when mounted vertically, and a different polarization when mounted horizontally. That is, a vertically mounted antenna emits a vertically polarized signal 805 and a horizontally mounted antenna emits a horizontally polarized signal 810.

In the most general case, polarization is elliptical 815, meaning that the polarization of the radio waves varies over time (i.e., vertically to horizontally). Two special cases are linear polarization 805 (the ellipse collapses into a line) and circular polarization 815 (in which the two axes of the ellipse are equal).

In linear polarization 805, the antenna compels the electric field of the emitted radio wave to a particular orientation. Depending upon the orientation of the antenna mounting, the usual linear cases are horizontal polarization and vertical polarization.

In circular polarization 815, the antenna continuously varies the electric field of the radio wave through all possible values of its orientation with regard to the Earth's surface. Circular polarizations 815 are classified as Right Hand Circularly Polarized (RHCP) and Left Hand Circularly Polarized (LHCP), that is appearing clockwise rotating or counter-clockwise rotating. In this disclosure, polarization is defined from the point of view of the source. Therefore, left or right handedness is determined by pointing one's left or right thumb away from the source, in the same direction that the wave is propagating, and matching the curling of one's fingers to the direction of the temporal rotation of the field at a given point in space. In other words, if the rotation is clockwise looking in the direction of propagation, the sense is called Right Hand Circular Polarization (RHCP). If the rotation is counterclockwise, the sense is called Left Hand Circular Polarization (LHCP).

In certain embodiments, the polarization forms an oval shape 820 in which a major axis 825 of the oval 820 is larger than a minor axis 830 of the oval 820. The oval shape 820 can also have multiple orientations wherein the major axis 825 is vertical, horizontal or diagonal. In certain embodiments, the major axis 825 and minor axis 830 vary over time. Oval (also referenced as elliptical) polarizations 820 also are classified as RHCP and LHCP.

Cross polarization (sometimes referenced as X-pol) is the polarization orthogonal to the polarization being discussed. For example, if the fields from an antenna are meant to be horizontally polarized, the cross-polarization in this case is vertical polarization. If the polarization is RHCP, the cross-polarization is LHCP.

Many wireless systems employ adaptive antenna arrays at the transmitter and the receiver. However, the antenna arrays for these systems are generally implemented in a linearly polarized fashion. However, polarization is generally effected on reflections thereby resulting in drastically degraded signal when there is a mismatch between the receive antenna polarization and the signal received at the antenna. For example, when the received signal is vertically polarized and the receiving antenna is horizontally polarized and vice versa, losses greater than 10 dB can be expected.

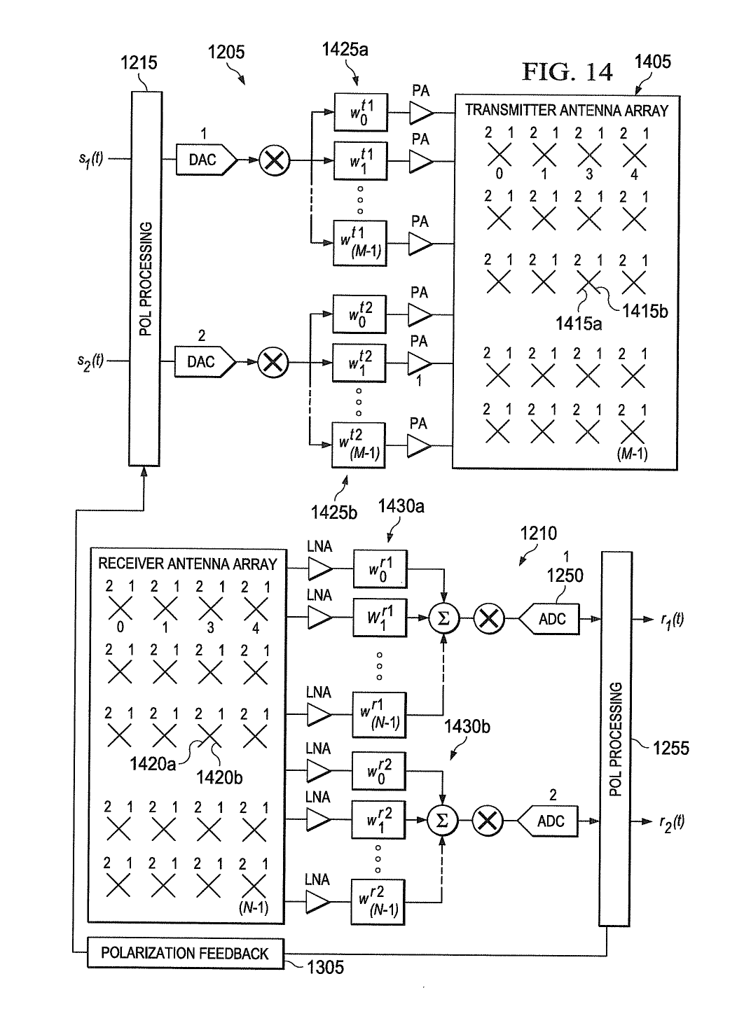

FIG. 9 illustrates cross polarization according to embodiments of the present disclosure. The embodiments of the cross polarizations shown in FIG. 9 are for illustration only. Other embodiments could be used without departing from the scope of this disclosure.

In certain embodiments, an antenna array system, and associated apparatus and methods, enable aligning the polarization between the transmitter and receiver in an adaptive manner.

According to elliptical polarization, the polarization of electromagnetic radiation is such that the tip of the electric field vector describes an ellipse in any fixed plane intersecting, and normal to, the direction of propagation. An elliptically polarized wave may be resolved into two linearly polarized waves in phase quadrature, with their polarization planes at right angles to each other. Since the electric field can rotate clockwise or counterclockwise as it propagates, Right Hand Elliptical Polarization (RHEP) and Left Hand Elliptical Polarization (LHEP) can be differentiated. Furthermore, other forms of polarization, such as circular and linear polarization, can be considered to be special cases of elliptical polarization.

In the case of a circularly polarized wave, the tip of the electric field vector, at a given point in space, describes a circle as time progresses. Similar to elliptical polarization, the electric field rotates either clockwise or counterclockwise as it propagates, thus exhibiting RHCP or LHCP. A number of different types of antenna elements such as dipole elements, helical elements or patch elements are utilized to produce circularly polarized radiation.

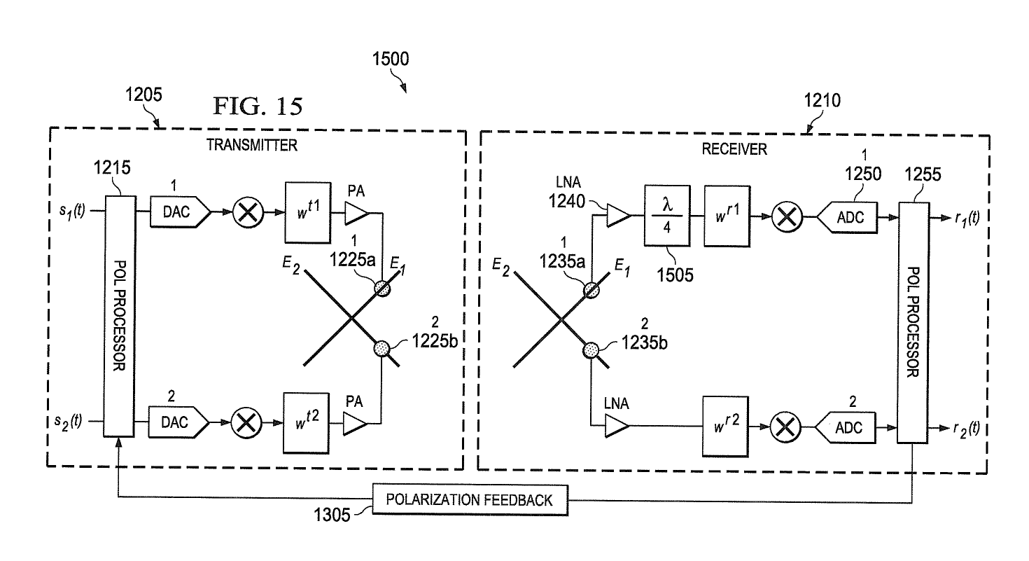

Cross polarized antennas 905 and 910 create RHCP 915 and LHCP 920. For example, the circularly polarized wave is generated by using two antennas 905a and 905b such as dipoles where the first antenna 905a is placed in Vertical position and the second antenna 905b in Horizontal position. The antennas 905a and 905b are orthogonal to each other. That is, the angle between these two antennas is 90°. Therefore, it is also possible to place these antennas on “X” arrangement 910, the first one antenna 910a with angle of 45° and the second antenna 910b with angle 135°. The electric fields from the two cross-polarized polarized antennas 905a and 905b (or 910a and 910b) are represented as E₁ and E₂. The RHCP wave 915 is generated when the field E₂ is leading the field E₁ by 90° degrees (π/2 radians) as shown in FIG. 10. Similarly LHCP wave is generated when the field E₁ is leading the field E₂ by 90° degrees (π/2 radians) as shown in FIG. 11.

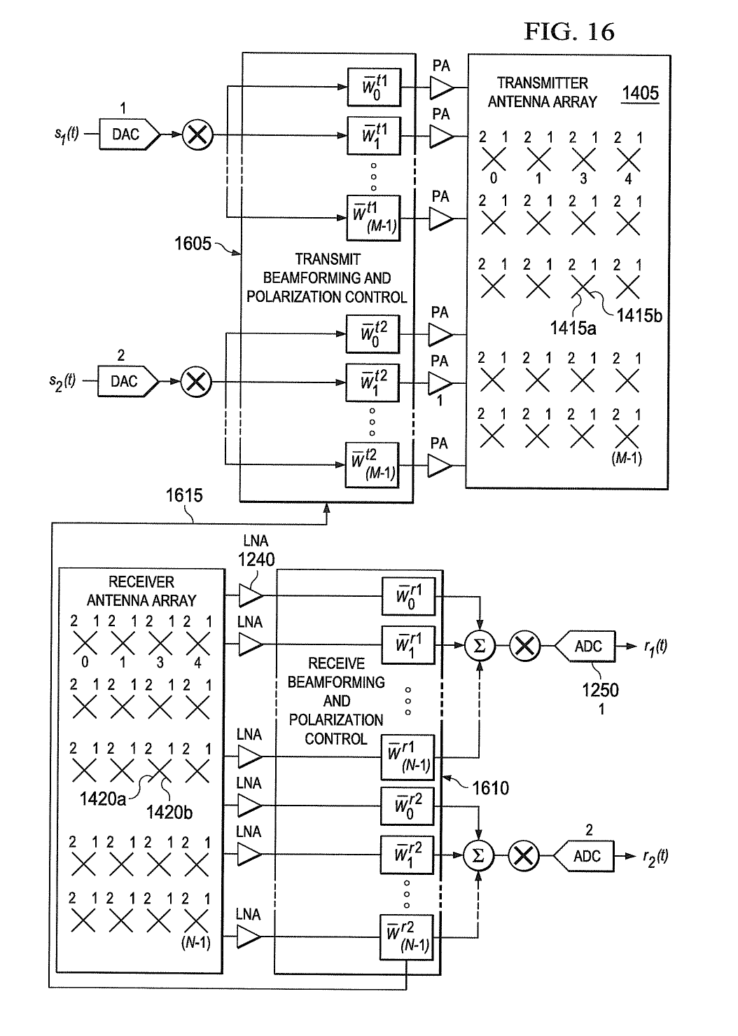

FIG. 12 illustrates a system capable of polarization alignment according to embodiments of the present disclosure. The embodiment of the system 1200 shown in FIG. 12 is for illustration only. Other embodiments could be used without departing from the scope of this disclosure.

The system 1200 is configured as a polarization alignment wireless communication system. The system 1200 includes a transmitter 1205 and a receiver 1210. Both the transmitter 1205 and receiver 1210 use cross-polarized antennas. The two digital signals S₁ and S₂ are processed by a transmitter polarization processor 1215, converted to analog signals by a Digital to Analog Converter (DAC) 1220, up-converted to RF and transmitted from antenna-1 1225-a and antenna-2 1225b respectively. After up-conversion, the two signals are weighted by RF gains and phase shifts implemented by the blocks W^{t1} 1230a and W^{t2} 1230b before transmissions from the cross-polarized antenna-1 1225a and antenna-2 1225b respectively.

The transmitter polarization processor 1215 includes processing circuitry configured to alter the polar orientation of the signals to be transmitted. That is, the transmitter polarization processor 1215 is configured to perform a series of calculations to alter the polarization of the signals. In addition, the transmitter polarization processor 1215 either performs the necessary actions to alter the polarization signals or instructs other components in the transmitter 1205 to alter the polarization signals based on the calculations made by the transmitter polarization processor 1215.

The receiver 1210 receives the signals via the cross-polarized antenna-1 1235a and antenna-2 1235b. Low Noise Amplifiers (LNA) 1240 amplifies the received signals. The received signal is weighted by RF gains and phase shifts implemented by the blocks W^{r1} 1245a and W^{r2} 1245b, and down-converted from RF. The down-converted signals are further converted to digital signals by an Analog to Digital Converter (ADC) 1250 and processed by a receiver polarization processor 1255.

The receiver polarization processor 1255 includes processing circuitry configured to alter the polar orientation of the receiver to align with the received signals. That is, the receiver polarization processor 1255 is configured to perform a series of calculations to alter the polarization of the receiver 1210. In addition, the receiver polarization processor 1255 either performs the necessary actions to alter the polarization signals or instructs other components in the receiver 1210 to alter the polarization signals based on the calculations made by the receiver polarization processor 1255.

The received signals can be written as:

$$[ \begin{matrix}{r}_{1} \\ {r}_{2}\end{matrix} ] = {P}_{r} {HP}_{t} [ \begin{matrix}{s}_{1} \\ {s}_{2}\end{matrix} ] + [ \begin{matrix}{n}_{1} \\ {n}_{2}\end{matrix} ] \qquad [ Eqn . 1 ]$$

where Pₜ and Pᵣ are transmitter and receiver polarization processing matrices respectively, H is channel matrix and n₁ and n₂ are noise components added to the signals received on the two cross-polarized antennas 1235.

For simplicity, in some examples, the RF gains and phase shifts at the transmitter and the receiver are not addressed in detail.

W^{t1}=W^{t2}=W^{r1}=W^{r2}=1

The transmitter polarization processing matrices for RHCP and LHCP can be written as:

$${P}_{t}^{RHCP} = [ \begin{matrix}1 & 0 \\ 0 & {e}^{j \frac{π}{2}}\end{matrix} ] \\ {P}_{t}^{LHCP} = [ \begin{matrix}{e}^{j \frac{π}{2}} & 0 \\ 0 & 1\end{matrix} ] \qquad [ Eqn . 2 ]$$

For RHCP, the signal transmitted from antenna-2 1225b, S₂ (field E₂) is leading the signal transmitted from antenna-1 1225a, S₁ (field E₁) by 90° degrees (π/2 radians). Similarly for LHCP, the signal transmitted from antenna-1 1225a, S₁ (field E₁) is leading the signal transmitted from antenna-2 1225b, S₂ (field E₂) by 90° degrees (π/2 radians).

The radio signals are reflected or absorbed depending upon the material with which they come in contact. The linear polarized antennas 1225 and 1235 are able to “attack” the problem in only one plane, that is, if the reflecting surface does not reflect the signal precisely in the same plane, that signal strength will be lost. Since circular polarized antennas send and receive in all planes, the signal strength is not lost, but is transferred to a different plane.

In a circularly-polarized antenna, the plane of polarization rotates in a corkscrew pattern making one complete revolution during each wavelength. A circularly polarized wave radiates energy in the horizontal and vertical planes as well as in every plane in between. The circularly-polarized systems also incur reflected signals, but the reflected signal may be returned in the opposite orientation, that is a RHCP wave is reflected as a LHCP wave and a LHCP wave is reflected as a RHCP wave.

FIG. 13 illustrates a system capable of polarization alignment using a feedback message according to embodiments of the present disclosure. The embodiment of the polarization alignment shown in FIG. 13 is for illustration only. Other embodiments could be used without departing from the scope of this disclosure.

In certain embodiments, the receiver 1210 is configured to receive either a RHCP or an LHCP wave. In this case, the receiver polarization processor 1255 provides information on its preferred polarization orientation, RHCP or LHCP, in a polarization feedback message 1305 to the transmitter 1205. The transmitter 1205 can then align the polarization orientation to the one that the receiver 1210 is configured to receive.

When the polarization orientation is changed, such as by reflection, the receiver polarization processor 1255 detects the change in the polarization orientation and provides this information in the polarization feedback message 1305 to the transmitter 1205. That is, the receiver polarization processor detects a difference between the polarization orientation of the received signal and the polarization orientation of the antenna 1235 and provides this information in the polarization feedback message 1305 to the transmitter 1205. The transmitter 1205 then alters or otherwise aligns the polarization orientation at the transmitter 1205 so that the receiver 1210 receives the wave with the desired polarization orientation. For example, the receiver 1210 can be configured to receive RHCP polarization orientation only and the transmitter 1205 is configurable to transmit in both RHCP and LHCP polarization orientations. In this case, under normal conditions when there is no change in polarization orientation for the transmitted wave from the transmitter 1205 to the receiver 1210, the transmitter 1205 uses RHCP polarization orientation and the receiver 1210 receives this RHCP polarization orientation wave. When RHCP polarization orientation changes upon reflection to LHCP, the receiver 1210 transmits the polarization feedback message 1305 indicating the change and, in response, the transmitter 1205 changes the polarization orientation to LHCP. The LHCP polarization orientation wave changes to RHCP on reflection and the receiver 1210 receives the wave in the correct polarization orientation. In this way, the receiver 1210 can make sure to receive the wave in the correct polarization orientation.

In certain embodiments, the transmitter polarization processor 1215 alters the polarization in response to a first polarization feedback message 1305. In response, the receiver polarization processor 1255 sends a second polarization feedback message 1305 informing the transmitter 1205 regarding the received signal. In response the transmitter polarization processor 1215 alters the polarization again in response to the second polarization feedback message 1305. In response, the receiver polarization processor 1255 sends a third polarization feedback message 1305 informing the transmitter 1205 regarding the received signal (i.e., whether the signal as improved or degraded). The transmitter 1205 and receiver 1310 repeat this process until the polarization orientation producing the strongest received signal is determined. That is, the transmitter 1205 and receiver 1305 can iteratively determine a polarization necessary to transmit and receive the signals.

In certain embodiments, the receiver 1210 is configurable to receive waves in both RHCP and LHCP polarization orientations. In this case, the receiver polarization processor 1255 detects the change in the polarization orientation of the received wave and configures itself for the received polarization orientation. In this way, the receiver 1210 ensures that it receives the wave in the correct polarization orientation. For example, when RHCP polarization orientation changes upon reflection to LHCP, the receiver 1205 changes the receive polarization orientation to LHCP. The receiver 1210 receives the wave in the correct polarization orientation without sending the polarization feedback message 1305.

In certain embodiments, the digital signals S₁ and S₂ can carry the same information, that is S₁=S₂.

FIG. 14 illustrates another system capable of polarization alignment for an antenna array using feedback according to embodiments of the present disclosure. The embodiment of the polarization alignment shown in FIG. 14 is for illustration only. Other embodiments could be used without departing from the scope of this disclosure.

In certain embodiments, the transmitter 1205 and receiver 1210 use cross-polarized antenna arrays 1405 and 1410 to generate and receive circular polarized waves. The transmitter array 1405 consists of (M−1) cross-polarized antennas 1415 while the receiver array 1410 consists of (N−1) cross-polarized antennas 1420. The two digital signals s₁ and s₂ are processed by the transmitter polarization processor 1215, converted to analog signals by the DAC 1220 and up-converted to RF. Each signal is split into (M−1) identical signals for transmission from each of the antennas in the antenna array. After up-conversion and splitting, the two signals s₁ and s₂ are further weighted by RF gains and phase shifts implemented by the blocks W₀^{t1}-W_{(M-1)}^{t1} 1425a and W₀^{t2}-W_{(M-1)}^{t2} 1425b respectively before transmissions from the cross-polarized antenna-1 1415a and antenna-2 1415b within the antenna array 1405 respectively.

The receiver 1210 receives the signal via the cross-polarized antenna-1 1420a and antenna-2 1420b within the receive antenna array 1410. The received signals are amplified by LNAs 1240, weighted by RF gains and phase shifts implemented by the blocks W₀^{r1}-W_{(N-1)}^{t} 1430a and W₀^{r2}-W_{(N-1)}^{r2} 1430b and down-converted from RF. The down-converted signals from each polarization of the cross-polarized antenna-1 1420a and antenna-2 1420b are combined and further converted to digital signals by an ADC 1250 and processed by the receiver polarization processor 1255.

The receiver polarization processor 1255 detects a change in the polarization orientation of the received wave and either configures itself for the received polarization orientation or informs the transmitter 1205 to change the polarization orientation using the polarization feedback message 1305. Therefore, the receiver 1210 is configured to make sure that the receiver 1210 receives the wave in correct polarization orientation.

In certain embodiments, the digital signals s₁ and s₂ carry the same information, that is s₁=s₂.

FIG. 15 illustrates another system capable of polarization alignment using feedback according to embodiments of the present disclosure. The embodiment of the polarization alignment shown in FIG. 15 is for illustration only. Other embodiments could be used without departing from the scope of this disclosure.

In certain embodiments, the polarization orientation of the wave generated is determined by the hardware and cannot be changed dynamically. For example, one way to obtain the 90° time-phase difference between the two orthogonal field components radiated by the two antennas is by feeding one of the two antennas with a transmission line that is ¼ wavelength longer or shorter than that of the other antenna. In the case of patch antennas, circular and elliptical polarizations can be obtained using various feed arrangements or slight modifications made to the elements. The circular polarization can be obtained if two orthogonal modes are excited with a 90° time-phase difference between them. This can be accomplished by adjusting the physical dimensions of the patch. For a square patch element, one method to excite circular polarization is to feed the element at two adjacent edges.

In the system 1500, the receiver 1210 includes a λ/4 addition 1505 to transmission line to antenna-1 1235a. The λ/4 addition 1505 introduces a 90° time-phase difference between the two orthogonal field components received on the two antennas 1235, which causes the receive antennas to receive RHCP wave only. In this case, the receiver 1210 is unable to change its polarization orientation when, for example, the received wave exhibits an LHCP orientation. The receiver polarization processor 1255 detects the change in the polarization orientation of the received wave and informs the transmitter 1205 using the polarization feedback message 1305 to change the polarization orientation. The 90° phase difference between the two orthogonal field components is applied in the transmitter polarization processor 1215.

In certain embodiments, the transmitter 1205 uses a fixed polarization using one of the hardware methods mentioned above but receiver 1210 is able to change its polarization orientation using the signal processing techniques. That is, the 90° phase difference between the two orthogonal fields components is applied by the Receiver Polarization Processor 1255.

FIG. 16 illustrates another system capable of polarization alignment according to embodiments of the present disclosure. The embodiment of the polarization alignment shown in FIG. 16 is for illustration only. Other embodiments could be used without departing from the scope of this disclosure.

In certain embodiments, the transmitter polarization processor 1215 and a beamformer are combined and a transmit beamforing and polarization control 1605 that performs transmission polarization and beamforming. The transmitter polarization processor 1215 operation is combined with the beamforming weights implemented by the blocks W₀^{t1}-W_{(M-1)}^{t1} 1425a and W₀^{t2}-W_{(M-1)}^{t2} 1425b before transmissions from the cross-polarized antenna-1 1415a and antenna-2 1415b within the antenna array 1405. These beamforming weights can be written as:

$$[ \begin{matrix}{W}_{0}^{t 1} \\ {W}_{1}^{t 1} \\ ⋮ \\ {W}_{( M - 1 )}^{t 1}\end{matrix} ] = [ \begin{matrix}{a}_{0}^{t 1} {e}^{{jφ}_{0}^{t 1}} \\ {a}_{1}^{t 1} {e}^{{jφ}_{1}^{t 1}} \\ ⋮ \\ {a}_{( M - 1 )}^{t 1} {e}^{j {φ}_{( M - 1 )}^{t 1}}\end{matrix} ] \\ [ \begin{matrix}{W}_{0}^{t 2} \\ {W}_{1}^{t 2} \\ ⋮ \\ {W}_{( M - 1 )}^{t 2}\end{matrix} ] = [ \begin{matrix}{a}_{0}^{t 2} {e}^{{jφ}_{0}^{t 2}} \\ {a}_{1}^{t 2} {e}^{{jφ}_{1}^{t 2}} \\ ⋮ \\ {a}_{( M - 1 )}^{t 2} {e}^{j {φ}_{( M - 1 )}^{t 2}}\end{matrix} ] \qquad [ Eqn . 3 ]$$

where a represents the amplitude component of the weight while φ represents the phase component of the beamforming weight (a corresponding equation can be used by the receiver 1210). In order to generate, for example, a RHCP orientation, the beamforming weights W₀^{t1}-W_{(M-1)}^{t1} 1425a applied to the antennas-1 1415a can be rotated by 90° degrees (π/2 radians) as below:

$$[ \begin{matrix}{\overline{W}}_{0}^{t 1} \\ {\overline{W}}_{1}^{t 1} \\ ⋮ \\ {\overline{W}}_{( M - 1 )}^{t 1}\end{matrix} ] = [ \begin{matrix}{a}_{0}^{t 1} {e}^{j {φ}_{0}^{t 1}} \\ {a}_{1}^{t 1} {e}^{j {φ}_{1}^{t 1}} \\ ⋮ \\ {a}_{( M - 1 )}^{t 1} {e}^{j {φ}_{( M - 1 )}^{t 1}}\end{matrix} ] \cdot [ \begin{matrix}{e}^{j \frac{π}{2}} \\ {e}^{j \frac{π}{2}} \\ ⋮ \\ {e}^{j \frac{π}{2}}\end{matrix} ] = [ \begin{matrix}{a}_{0}^{t 1} {e}^{j ( {φ}_{0}^{t 1} + \frac{π}{2} )} \\ {a}_{1}^{t 1} {e}^{j ( {φ}_{1}^{t 1} + \frac{π}{2} )} \\ ⋮ \\ {a}_{( M - 1 )}^{t 1} {e}^{j ( {φ}_{( M - 1 )}^{t 1} + \frac{π}{2} )}\end{matrix} ] \\ [ \begin{matrix}{\overline{W}}_{0}^{t 2} \\ {\overline{W}}_{1}^{t 2} \\ ⋮ \\ {\overline{W}}_{( M - 1 )}^{t 2}\end{matrix} ] = [ \begin{matrix}{a}_{0}^{t 2} {e}^{j {φ}_{0}^{t 2}} \\ {a}_{1}^{t 2} {e}^{j {φ}_{1}^{t 2}} \\ ⋮ \\ {a}_{( M - 1 )}^{t 2} {e}^{j {φ}_{( M - 1 )}^{t 2}}\end{matrix} ] \cdot [ \begin{matrix}1 \\ 1 \\ ⋮ \\ 1\end{matrix} ] = [ \begin{matrix}{a}_{0}^{t 2} {e}^{j {φ}_{0}^{t 2}} \\ {a}_{1}^{t 2} {e}^{j {φ}_{1}^{t 2}} \\ ⋮ \\ {a}_{( M - 1 )}^{t 2} {e}^{j {φ}_{( M - 1 )}^{t 2}}\end{matrix} ] \qquad [ Eqn . 4 ]$$

where W̅₀^{t1}- W̅_{(M-1)}^{t1} and W̅₀^{t2}- W̅_{(M-1)}^{t2} represent new weights applied to the cross-polarized antenna-1 1415a and antenna-2 1415b within the antenna array 1405. For RHCP, the weights applied to antenna-2 1415b are not modified due to polarization consideration.

Similarly, in order to generate a LHCP orientation, the beamforming weights W₀^{t2}-W_{(M-1)}^{t2} 1425b applied to the antennas-2 1415b can be rotated by 90° degrees (π/2 radians) as below:

$$[ \begin{matrix}{\overline{W}}_{0}^{t 1} \\ {\overline{W}}_{1}^{t 1} \\ ⋮ \\ {\overline{W}}_{( M - 1 )}^{t 1}\end{matrix} ] = [ \begin{matrix}{a}_{0}^{t 1} {e}^{j {φ}_{0}^{t 1}} \\ {a}_{1}^{t 1} {e}^{j {φ}_{1}^{t 1}} \\ ⋮ \\ {a}_{( M - 1 )}^{t 1} {e}^{j {φ}_{( M - 1 )}^{t 1}}\end{matrix} ] \cdot [ \begin{matrix}1 \\ 1 \\ ⋮ \\ 1\end{matrix} ] = [ \begin{matrix}{a}_{0}^{t 1} {e}^{{jφ}_{0}^{t 1}} \\ {a}_{1}^{t 1} {e}^{{jφ}_{1}^{t 1}} \\ ⋮ \\ {a}_{( M - 1 )}^{t 1} {e}^{j {φ}_{( M - 1 )}^{t 1}}\end{matrix} ] \\ [ \begin{matrix}{\overline{W}}_{0}^{t 2} \\ {\overline{W}}_{1}^{t 2} \\ ⋮ \\ {\overline{W}}_{( M - 1 )}^{t2}\end{matrix} ] = [ \begin{matrix}{a}_{0}^{t 2} {e}^{j {φ}_{0}^{t 2}} \\ {a}_{1}^{t 2} {e}^{j {φ}_{1}^{t 2}} \\ ⋮ \\ {a}_{( M - 1 )}^{t 2} {e}^{j {φ}_{( M - 1 )}^{t 2}}\end{matrix} ] \cdot [ \begin{matrix}{e}^{j \frac{π}{2}} \\ {e}^{j \frac{π}{2}} \\ ⋮ \\ {e}^{j \frac{π}{2}}\end{matrix} ] = [ \begin{matrix}{a}_{0}^{t 2} {e}^{j ( {φ}_{0}^{t 2} + \frac{π}{2} )} \\ {a}_{1}^{t 2} {e}^{j ( {φ}_{1}^{t 2} + \frac{π}{2} )} \\ ⋮ \\ {a}_{( M - 1 )}^{t 2} {e}^{j ( {φ}_{( M - 1 )}^{t 2} + \frac{π}{2} )}\end{matrix} ] \qquad [ Eqn . 5 ]$$

where W̅₀^{t1}- W̅_{(M-1)}^{t1} and W̅₀^{t2}- W̅_{(M-1)}^{t2} represent new weights applied to the cross-polarized antenna-1 1415a and antenna-2 1415b within the antenna array 1405. For LHCP, the weights applied to antenna-1 1415a are not modified due to polarization consideration.

The receiver receives the signals from the cross-polarized antenna-1 1420a and antenna-2 1420b within the receive antenna array 1410. The received signals are amplified by LNAs 1240, weighted by RF gains and phase shifts implemented by the blocks W̅₀^{r1}- W̅_{(N-1)}^{r1} and W̅₀^{r2}- W̅_{(N-1)}^{r2} and down-converted from RF. The down-converted signals from each polarization of the cross-polarized antenna-1 1420a and antenna-2 1420b are combined and further converted to digital signals by an ADC 1250 and processed by the receive beamforming and polarization control 1610.

In order to generate an RHCP orientation in the receiver 1210, the beamforming weights W₀^{r1}-W_{(M-1)}^{r1} applied to the antennas-1 1420a can be rotated by 90° degrees (π/2 radians) as below:

$$[ \begin{matrix}{\overline{W}}_{0}^{r 1} \\ {\overline{W}}_{1}^{r 1} \\ ⋮ \\ {\overline{W}}_{( N - 1 )}^{r 1}\end{matrix} ] = [ \begin{matrix}{a}_{0}^{r 1} {e}^{j {φ}_{0}^{r 1}} \\ {a}_{1}^{r 1} {e}^{j {φ}_{1}^{r 1}} \\ ⋮ \\ {a}_{( N - 1 )}^{r 1} {e}^{j {φ}_{( N - 1 )}^{r 1}}\end{matrix} ] \cdot [ \begin{matrix}{e}^{j \frac{π}{2}} \\ {e}^{j \frac{π}{2}} \\ ⋮ \\ {e}^{j \frac{π}{2}}\end{matrix} ] = [ \begin{matrix}{a}_{0}^{r 1} {e}^{j ( {φ}_{0}^{r 1} + \frac{π}{2} )} \\ {a}_{1}^{r 1} {e}^{j ( {φ}_{1}^{r 1} + \frac{π}{2} )} \\ ⋮ \\ {a}_{( N - 1 )}^{r 1} {e}^{j ( {φ}_{( N - 1 )}^{r 1} + \frac{π}{2} )}\end{matrix} ] \\ [ \begin{matrix}{\overline{W}}_{0}^{r 2} \\ {\overline{W}}_{1}^{r 2} \\ ⋮ \\ {\overline{W}}_{( N - 1 )}^{r 2}\end{matrix} ] = [ \begin{matrix}{a}_{0}^{r 2} {e}^{j {φ}_{0}^{r 2}} \\ {a}_{1}^{r 2} {e}^{j {φ}_{1}^{r 2}} \\ ⋮ \\ {a}_{( N - 1 )}^{r 2} {e}^{j {φ}_{( N - 1 )}^{r 2}}\end{matrix} ] \cdot [ \begin{matrix}1 \\ 1 \\ ⋮ \\ 1\end{matrix} ] = [ \begin{matrix}{a}_{0}^{r 2} {e}^{j ( {φ}_{0}^{r 1} + \frac{π}{2} )} \\ {a}_{1}^{r 1} {e}^{j ( {φ}_{1}^{r 1} + \frac{π}{2} )} \\ ⋮ \\ {a}_{( N - 1 )}^{r 2} {e}^{{jφ}_{( N - 1 )}^{r 2}}\end{matrix} ] \qquad [ Eqn . 6 ]$$

where W̅₀^{r1}- W̅_{(N-1)}^{r1} and W̅₀^{r2}- W̅_{(N-1)}^{r2} represent new weights applied to the cross-polarized antenna-1 1420a and antenna-2 1420b within the antenna array 1410. For RHCP, the weights applied to antenna-2 1420b are not modified due to polarization consideration.

Similarly, to generate an LHCP orientation at the receiver 1210, the beamforming weights W̅₀^{r2}- W̅_{(N-1)}^{r2} applied to the antennas-2 1420b can be rotated by 90° degrees (π/2 radians) as below:

$$[ \begin{matrix}{\overline{W}}_{0}^{r 1} \\ {\overline{W}}_{1}^{r 1} \\ ⋮ \\ {\overline{W}}_{( N - 1 )}^{r 1}\end{matrix} ] = [ \begin{matrix}{a}_{0}^{r 1} {e}^{j {φ}_{0}^{r 1}} \\ {a}_{1}^{r 1} {e}^{j {φ}_{1}^{r 1}} \\ ⋮ \\ {a}_{( N - 1 )}^{r 1} {e}^{j {φ}_{( N - 1 )}^{r 1}}\end{matrix} ] \cdot [ \begin{matrix}1 \\ 1 \\ ⋮ \\ 1\end{matrix} ] = [ \begin{matrix}{a}_{0}^{r 1} {e}^{j {φ}_{0}^{r 1}} \\ {a}_{1}^{r 1} {e}^{j {φ}_{1}^{r 1}} \\ ⋮ \\ {a}_{( N - 1 )}^{r 1} {e}^{{jφ}_{( N - 1 )}^{r 1}}\end{matrix} ] \\ [ \begin{matrix}{\overline{W}}_{0}^{r 2} \\ {\overline{W}}_{1}^{r 2} \\ ⋮ \\ {\overline{W}}_{( N - 1 )}^{r 2}\end{matrix} ] = [ \begin{matrix}{a}_{0}^{r 2} {e}^{j {φ}_{0}^{r 2}} \\ {a}_{1}^{r 2} {e}^{j {φ}_{1}^{r 2}} \\ ⋮ \\ {a}_{( N - 1 )}^{r 2} {e}^{j {φ}_{( N - 1 )}^{r 2}}\end{matrix} ] \cdot [ \begin{matrix}{e}^{j \frac{π}{2}} \\ {e}^{j \frac{π}{2}} \\ ⋮ \\ {e}^{j \frac{π}{2}}\end{matrix} ] = [ \begin{matrix}{a}_{0}^{r 2} {e}^{j ( {φ}_{0}^{r 2} + \frac{π}{2} )} \\ {a}_{1}^{r 2} {e}^{j ( {φ}_{1}^{r 2} + \frac{π}{2} )} \\ ⋮ \\ {a}_{( N - 1 )}^{r 2} {e}^{j ( {φ}_{( N - 1 )}^{r 2} + \frac{π}{2} )}\end{matrix} ] \qquad [ Eqn . 7 ]$$

where W̅₀^{r1}- W̅_{(N-1)}^{r1} and W̅₀^{r2}- W̅_{(N-1)}^{r2} represent new weights applied to the cross-polarized antenna-1 1420a and antenna-2 1420b within the antenna array 1410. For LHCP, the weights applied to antenna-1 are not modified due to polarization consideration.

Therefore, both beamforming control and polarization alignment are performed in a single functional block, the transmit beamforming and polarization control 1605, in the transmitter 1205 (and a single function block, the receive beamforming and polarization control 1610, in the receiver 1210) without requiring a separate polarization processor. In certain embodiments, an optional feedback 1615 enables the receiver 1210 to request a polarization orientation change at the transmitter 1205.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. For use in a wireless communication network, a transmitter comprising:
at least one cross-polarized antenna configured to transmit a signal; and
a polarization processor configured to alter a polarization orientation of the signal to align with a polarization orientation of a receiver.

2. The transmitter as set forth in claim 1, wherein the polarization orientation comprises at least one of: a vertical polarization, a horizontal polarization, an elliptical polarization, a circular polarization, a left hand polarization and a right hand polarization.

3. The transmitter as set forth in claim 1, wherein the polarization processor is configured to alter the polarization orientation in response to a feedback message received from the receiver.

4. The transmitter as set forth in claim 1, wherein the polarization processor is configured to alter the polarization orientation by weighting the signal with radio frequency (RF) gains and phase shifts.

5. The transmitter as set forth in claim 1, wherein the at least one cross-polarized antenna comprise an antenna array, the antenna array comprising “M” number of cross-polarized antenna.

6. The transmitter as set forth in claim 5, wherein the polarization processor further is configured to apply beamforming weights to the signal.

7. The transmitter as set forth in claim 6, wherein the beamforming weight is defined by at least one of:
$$[ \begin{matrix}{W}_{0}^{t 1} \\ {W}_{1}^{t 1} \\ ⋮ \\ {W}_{( M - 1 )}^{t 1}\end{matrix} ] = [ \begin{matrix}{a}_{0}^{t 1} {e}^{{jφ}_{0}^{t 1}} \\ {a}_{1}^{t 1} {e}^{j {φ}_{1}^{t 1}} \\ ⋮ \\ {a}_{( M - 1 )}^{t 1} {e}^{j {φ}_{( M - 1 )}^{t 1}}\end{matrix} ] \\ [ \begin{matrix}{W}_{0}^{t 2} \\ {W}_{1}^{t 2} \\ ⋮ \\ {W}_{( M - 1 )}^{t 2}\end{matrix} ] = [ \begin{matrix}{a}_{0}^{t 2} {e}^{{jφ}_{0}^{t 2}} \\ {a}_{1}^{t 2} {e}^{j {φ}_{1}^{t 2}} \\ ⋮ \\ {a}_{( M - 1 )}^{t 2} {e}^{j {φ}_{( M - 1 )}^{t 2}}\end{matrix} ] ; \\ [ \begin{matrix}{\overline{W}}_{0}^{t 1} \\ {\overline{W}}_{1}^{t 1} \\ ⋮ \\ {\overline{W}}_{( M - 1 )}^{t 1}\end{matrix} ] = [ \begin{matrix}{a}_{0}^{t 1} {e}^{{jφ}_{0}^{t 1}} \\ {a}_{1}^{t 1} {e}^{j {φ}_{1}^{t 1}} \\ ⋮ \\ {a}_{( M - 1 )}^{t 1} {e}^{j {φ}_{( M - 1 )}^{t 1}}\end{matrix} ] \cdot [ \begin{matrix}{e}^{j \frac{π}{2}} \\ {e}^{j \frac{π}{2}} \\ ⋮ \\ {e}^{j \frac{π}{2}}\end{matrix} ] = [ \begin{matrix}{a}_{0}^{t 1} {e}^{j ( {φ}_{0}^{t 1} + \frac{π}{2} )} \\ {a}_{1}^{t 1} {e}^{j ( {φ}_{1}^{t 1} + \frac{π}{2} )} \\ ⋮ \\ {a}_{( M - 1 )}^{t 1} {e}^{j ( {φ}_{( M - 1 )}^{t 1} + \frac{π}{2} )}\end{matrix} ] ;$$
$$and \\ [ \begin{matrix}{\overline{W}}_{0}^{t 2} \\ {\overline{W}}_{1}^{t 2} \\ ⋮ \\ {\overline{W}}_{( M - 1 )}^{t 2}\end{matrix} ] = [ \begin{matrix}{a}_{0}^{t 2} {e}^{{jφ}_{0}^{t 2}} \\ {a}_{1}^{t 2} {e}^{j {φ}_{1}^{t 2}} \\ ⋮ \\ {a}_{( M - 1 )}^{t 2} {e}^{j {φ}_{( M - 1 )}^{t 2}}\end{matrix} ] \cdot [ \begin{matrix}1 \\ 1 \\ ⋮ \\ 1\end{matrix} ] = [ \begin{matrix}{a}_{0}^{t 2} {e}^{{jφ}_{0}^{t 2}} \\ {a}_{1}^{t 2} {e}^{j {φ}_{1}^{t 2}} \\ ⋮ \\ {a}_{( M - 1 )}^{t 2} {e}^{j {φ}_{( M - 1 )}^{t 2}}\end{matrix} ] \\ [ \begin{matrix}{\overline{W}}_{0}^{t 1} \\ {\overline{W}}_{1}^{t 1} \\ ⋮ \\ {\overline{W}}_{( M - 1 )}^{t 1}\end{matrix} ] = [ \begin{matrix}{a}_{0}^{t 1} {e}^{{jφ}_{0}^{t 1}} \\ {a}_{1}^{t 1} {e}^{j {φ}_{1}^{t 1}} \\ ⋮ \\ {a}_{( M - 1 )}^{t 1} {e}^{j {φ}_{( M - 1 )}^{t 1}}\end{matrix} ] \cdot [ \begin{matrix}1 \\ 1 \\ ⋮ \\ 1\end{matrix} ] = [ \begin{matrix}{a}_{0}^{t 1} {e}^{{jφ}_{0}^{t 1}} \\ {a}_{1}^{t 1} {e}^{j {φ}_{1}^{t 1}} \\ ⋮ \\ {a}_{( M - 1 )}^{t 1} {e}^{j {φ}_{( M - 1 )}^{t 1}}\end{matrix} ] \\ [ \begin{matrix}{\overline{W}}_{0}^{t 2} \\ {\overline{W}}_{1}^{t 2} \\ ⋮ \\ {\overline{W}}_{( M - 1 )}^{t 2}\end{matrix} ] = [ \begin{matrix}{a}_{0}^{t 2} {e}^{{jφ}_{0}^{t2}} \\ {a}_{1}^{t 2} {e}^{j {φ}_{1}^{t 2}} \\ ⋮ \\ {a}_{( M - 1 )}^{t 2} {e}^{j {φ}_{( M - 1 )}^{t 2}}\end{matrix} ] \cdot [ \begin{matrix}{e}^{j \frac{π}{2}} \\ {e}^{j \frac{π}{2}} \\ ⋮ \\ {e}^{j \frac{π}{2}}\end{matrix} ] = [ \begin{matrix}{a}_{0}^{t 2} {e}^{j ( {φ}_{0}^{t 2} + \frac{π}{2} )} \\ {a}_{1}^{t 2} {e}^{j ( {φ}_{1}^{t 2} + \frac{π}{2} )} \\ ⋮ \\ {a}_{( M - 1 )}^{t 2} {e}^{j ( {φ}_{( M - 1 )}^{t 2} + \frac{π}{2} )}\end{matrix} ] ,$$
wherein W₀^{t1}-W_{(M-1)}^{t1} and W₀^{t2}-W_{(M-1)}^{t2} represent a first set of beamforming weights in which a represents the amplitude component of the weight while φ represents the phase component of the beamforming weight, and where W̅₀^{t1}- W̅_{(M-1)}^{t1} and W̅₀^{t2}- W̅_{(M-1)}^{t2} represent new weights applied to respective cross-polarized antenna within the antenna array.

8. For use in a wireless communication network, a receiver comprising:
at least one cross-polarized antenna configured to receive a signal; and
a polarization processor configured to cause a polarization orientation of the at least one cross-polarized antenna to align with a polarization orientation of the signal.

9. The receiver as set forth in claim 8, wherein the polarization orientation comprises at least one of: a vertical polarization, a horizontal polarization, an elliptical polarization, a circular polarization, a left hand polarization and a right hand polarization.

10. The receiver as set forth in claim 8, wherein the polarization processor is configured to alter the polarization orientation in response to detecting a difference between the polarization orientation of the received signal and the polarization orientation of the at least one cross-polarized antenna.

11. The receiver as set forth in claim 10, wherein the polarization processor is configured to change the polarization orientation of the at least one cross-polarized antenna.

12. The receiver as set forth in claim 10, wherein the polarization processor is configured to indicate the difference in a polarization feedback message sent to a transmitter.

13. The receiver as set forth in claim 8, wherein the polarization processor is configured to alter the polarization orientation by weighting the signal with radio frequency (RF) gains and phase shifts.

14. The receiver as set forth in claim 8, wherein the at least one cross-polarized antenna comprise an antenna array, the antenna array comprising “N” number of cross-polarized antenna.

15. The receiver as set forth in claim 14, wherein the polarization processor further is configured to apply beamforming weights to the signal.

16. The receiver as set forth in claim 15, wherein the beamforming weight is defined by at least one of:
$$[ \begin{matrix}{W}_{0}^{r 1} \\ {W}_{1}^{r 1} \\ ⋮ \\ {W}_{( N - 1 )}^{r 1}\end{matrix} ] = [ \begin{matrix}{a}_{0}^{r 1} {e}^{j {φ}_{0}^{r 1}} \\ {a}_{1}^{r 1} {e}^{j {φ}_{1}^{r 1}} \\ ⋮ \\ {a}_{( N - 1 )}^{r 1} {e}^{j {φ}_{( N - 1 )}^{r 1}}\end{matrix} ] \\ [ \begin{matrix}{W}_{0}^{r 2} \\ {W}_{1}^{r 2} \\ ⋮ \\ {W}_{( N - 1 )}^{r 2}\end{matrix} ] = [ \begin{matrix}{a}_{0}^{r 2} {e}^{j {φ}_{0}^{r 2}} \\ {a}_{1}^{r 2} {e}^{j {φ}_{1}^{r 2}} \\ ⋮ \\ {a}_{( N - 1 )}^{r 2} {e}^{j {φ}_{( N - 1 )}^{r 2}}\end{matrix} ] ; \\ [ \begin{matrix}{\overline{W}}_{0}^{r 1} \\ {\overline{W}}_{1}^{r 1} \\ ⋮ \\ {\overline{W}}_{( N - 1 )}^{r 1}\end{matrix} ] = [ \begin{matrix}{a}_{0}^{r 1} {e}^{j {φ}_{0}^{r 1}} \\ {a}_{1}^{r 1} {e}^{j {φ}_{1}^{r 1}} \\ ⋮ \\ {a}_{( N - 1 )}^{r 1} {e}^{j {φ}_{( N - 1 )}^{r 1}}\end{matrix} ] \cdot [ \begin{matrix}{e}^{j \frac{π}{2}} \\ {e}^{j \frac{π}{2}} \\ ⋮ \\ {e}^{j \frac{π}{2}}\end{matrix} ] = [ \begin{matrix}{a}_{0}^{r 1} {e}^{j ( {φ}_{0}^{r 1} + \frac{π}{2} )} \\ {a}_{1}^{r 1} {e}^{j ( {φ}_{1}^{r 1} + \frac{π}{2} )} \\ ⋮ \\ {a}_{( N - 1 )}^{r 1} {e}^{j ( {φ}_{( N - 1 )}^{r 1} + \frac{π}{2} )}\end{matrix} ] ;$$
$$and \\ [ \begin{matrix}{\overline{W}}_{0}^{r 2} \\ {\overline{W}}_{1}^{r 2} \\ ⋮ \\ {\overline{W}}_{( N - 1 )}^{r 2}\end{matrix} ] = [ \begin{matrix}{a}_{0}^{r 2} {e}^{j {φ}_{0}^{r 2}} \\ {a}_{1}^{r 2} {e}^{j {φ}_{1}^{r 2}} \\ ⋮ \\ {a}_{( N - 1 )}^{r2} {e}^{j {φ}_{( N - 1 )}^{r 2}}\end{matrix} ] \cdot [ \begin{matrix}1 \\ 1 \\ ⋮ \\ 1\end{matrix} ] = [ \begin{matrix}{a}_{0}^{r 2} {e}^{{jφ}_{0}^{r 2}} \\ {a}_{1}^{r 2} {e}^{j {φ}_{1}^{r 2}} \\ ⋮ \\ {a}_{( N - 1 )}^{r 2} {e}^{j {φ}_{( N - 1 )}^{r 2}}\end{matrix} ] \\ [ \begin{matrix}{\overline{W}}_{0}^{r 1} \\ {\overline{W}}_{1}^{r 1} \\ ⋮ \\ {\overline{W}}_{( N - 1 )}^{r 1}\end{matrix} ] = [ \begin{matrix}{a}_{0}^{r 1} {e}^{j {φ}_{0}^{r 1}} \\ {a}_{1}^{r 1} {e}^{j {φ}_{1}^{r 1}} \\ ⋮ \\ {a}_{( N - 1 )}^{r 1} {e}^{j {φ}_{( N - 1 )}^{r 1}}\end{matrix} ] \cdot [ \begin{matrix}1 \\ 1 \\ ⋮ \\ 1\end{matrix} ] = [ \begin{matrix}{a}_{0}^{r 1} {e}^{{jφ}_{0}^{r 1}} \\ {a}_{1}^{r 1} {e}^{j {φ}_{1}^{r 1}} \\ ⋮ \\ {a}_{( N - 1 )}^{r 1} {e}^{j {φ}_{( N - 1 )}^{r 1}}\end{matrix} ] \\ [ \begin{matrix}{\overline{W}}_{0}^{r 2} \\ {\overline{W}}_{1}^{r 2} \\ ⋮ \\ {\overline{W}}_{( N - 1 )}^{r2}\end{matrix} ] = [ \begin{matrix}{a}_{0}^{r 2} {e}^{j {φ}_{0}^{r 2}} \\ {a}_{1}^{r 2} {e}^{j {φ}_{1}^{r 2}} \\ ⋮ \\ {a}_{( N - 1 )}^{r 2} {e}^{j {φ}_{( N - 1 )}^{r 2}}\end{matrix} ] \cdot [ \begin{matrix}{e}^{j \frac{π}{2}} \\ {e}^{j \frac{π}{2}} \\ ⋮ \\ {e}^{j \frac{π}{2}}\end{matrix} ] = [ \begin{matrix}{a}_{0}^{r 2} {e}^{j ( {φ}_{0}^{r 2} + \frac{π}{2} )} \\ {a}_{1}^{r 2} {e}^{j ( {φ}_{1}^{r 2} + \frac{π}{2} )} \\ ⋮ \\ {a}_{( N - 1 )}^{r 2} {e}^{j ( {φ}_{( N - 1 )}^{r 2} + \frac{π}{2} )}\end{matrix} ] ,$$
wherein W₀^{r1}-W_{(N-1)}^{r1} and W₀^{r2}-W_{(N-1)}^{r2} represent a first set of beamforming weights in which a represents the amplitude component of the weight while φ represents the phase component of the beamforming weight, and where W̅₀^{r1}- W̅_{(N-1)}^{r1} and W̅₀^{r2}- W̅_{(N-1)}^{r2} represent new weights applied to respective cross-polarized antenna within the antenna array.

17. For use in a wireless communication network, a method comprising:
aligning, by a polarization processor, a polarization orientation of at least one cross-polarized antenna at a receiver with a polarization orientation of a transmitted signal.

18. The method as set forth in claim 17, wherein the polarization orientation comprises at least one of: a vertical polarization, a horizontal polarization, an elliptical polarization, a circular polarization, a left hand polarization and a right hand polarization.

19. The method as set forth in claim 17, wherein aligning comprises altering the polarization orientation in response to detecting a difference between the polarization orientation of the received signal and the polarization orientation of the at least one cross-polarized antenna.

20. The method as set forth in claim 19, wherein aligning comprises changing the polarization orientation of the at least one cross-polarized antenna.

21. The method as set forth in claim 19, further comprising indicating the difference in a polarization feedback message sent to a transmitter.

22. The method as set forth in claim 17, wherein aligning comprises altering the polarization orientation by weighting the signal with radio frequency (RF) gains and phase shifts.

23. The method as set forth in claim 17, wherein the at least one cross-polarized antenna comprise an antenna array, the antenna array comprising a number of cross-polarized antenna.

24. The receiver as set forth in claim 23, wherein the polarization processor further is configured to apply beamforming weights to the signal.

25. The method as set forth in claim 24, wherein the beamforming weight is defined by at least one of:
$$[ \begin{matrix}{W}_{0}^{t 1} \\ {W}_{1}^{t 1} \\ ⋮ \\ {W}_{( M - 1 )}^{t 1}\end{matrix} ] = [ \begin{matrix}{a}_{0}^{t 1} {e}^{j {φ}_{0}^{t 1}} \\ {a}_{1}^{t 1} {e}^{j {φ}_{1}^{t 1}} \\ ⋮ \\ {a}_{( M - 1 )}^{t 1} {e}^{j {φ}_{( M - 1 )}^{t 1}}\end{matrix} ] \\ [ \begin{matrix}{W}_{0}^{t 2} \\ {W}_{1}^{t 2} \\ ⋮ \\ {W}_{( M - 1 )}^{t 2}\end{matrix} ] = [ \begin{matrix}{a}_{0}^{t 2} {e}^{j {φ}_{0}^{t 2}} \\ {a}_{1}^{t 2} {e}^{j {φ}_{1}^{t 2}} \\ ⋮ \\ {a}_{( M - 1 )}^{t 2} {e}^{j {φ}_{( M - 1 )}^{t 2}}\end{matrix} ] ; \\ [ \begin{matrix}{\overline{W}}_{0}^{t 1} \\ {\overline{W}}_{1}^{t 1} \\ ⋮ \\ {\overline{W}}_{( M - 1 )}^{t 1}\end{matrix} ] = [ \begin{matrix}{a}_{0}^{t 1} {e}^{j {φ}_{0}^{t 1}} \\ {a}_{1}^{t 1} {e}^{j {φ}_{1}^{t 1}} \\ ⋮ \\ {a}_{( M - 1 )}^{t 1} {e}^{j {φ}_{( M - 1 )}^{t 1}}\end{matrix} ] \cdot [ \begin{matrix}{e}^{j \frac{π}{2}} \\ {e}^{j \frac{π}{2}} \\ ⋮ \\ {e}^{j \frac{π}{2}}\end{matrix} ] = [ \begin{matrix}{a}_{0}^{t 1} {e}^{j ( {φ}_{0}^{t 1} + \frac{π}{2} )} \\ {a}_{1}^{t 1} {e}^{j ( {φ}_{1}^{t 1} + \frac{π}{2} )} \\ ⋮ \\ {a}_{( M - 1 )}^{t 1} {e}^{j ( {φ}_{( M - 1 )}^{t 1} + \frac{π}{2} )}\end{matrix} ] ;$$
$$and \\ [ \begin{matrix}{\overline{W}}_{0}^{t 2} \\ {\overline{W}}_{1}^{t 2} \\ ⋮ \\ {\overline{W}}_{( M - 1 )}^{t 2}\end{matrix} ] = [ \begin{matrix}{a}_{0}^{t 2} {e}^{j {φ}_{0}^{t 2}} \\ {a}_{1}^{t 2} {e}^{j {φ}_{1}^{t 2}} \\ ⋮ \\ {a}_{( M - 1 )}^{t 2} {e}^{j {φ}_{( M - 1 )}^{t 2}}\end{matrix} ] \cdot [ \begin{matrix}1 \\ 1 \\ ⋮ \\ 1\end{matrix} ] = [ \begin{matrix}{a}_{0}^{t 2} {e}^{j {φ}_{0}^{t 2}} \\ {a}_{1}^{t 2} {e}^{j {φ}_{1}^{t 2}} \\ ⋮ \\ {a}_{( M - 1 )}^{t 2} {e}^{j {φ}_{( M - 1 )}^{t 2}}\end{matrix} ] \\ [ \begin{matrix}{\overline{W}}_{0}^{t 1} \\ {\overline{W}}_{1}^{t 1} \\ ⋮ \\ {\overline{W}}_{( M - 1 )}^{t 1}\end{matrix} ] = [ \begin{matrix}{a}_{0}^{t 1} {e}^{j {φ}_{0}^{t 1}} \\ {a}_{1}^{t 1} {e}^{j {φ}_{1}^{t 1}} \\ ⋮ \\ {a}_{( M - 1 )}^{t 1} {e}^{j {φ}_{( M - 1 )}^{t 1}}\end{matrix} ] \cdot [ \begin{matrix}1 \\ 1 \\ ⋮ \\ 1\end{matrix} ] = [ \begin{matrix}{a}_{0}^{t 1} {e}^{j {φ}_{0}^{t 1}} \\ {a}_{1}^{t 1} {e}^{j {φ}_{1}^{t 1}} \\ ⋮ \\ {a}_{( M - 1 )}^{t 1} {e}^{j {φ}_{( M - 1 )}^{t 1}}\end{matrix} ] \\ [ \begin{matrix}{\overline{W}}_{0}^{t 2} \\ {\overline{W}}_{1}^{t 2} \\ ⋮ \\ {\overline{W}}_{( M - 1 )}^{t 2}\end{matrix} ] = [ \begin{matrix}{a}_{0}^{t 2} {e}^{j {φ}_{0}^{t 2}} \\ {a}_{1}^{t 2} {e}^{j {φ}_{1}^{t 2}} \\ ⋮ \\ {a}_{( M - 1 )}^{t 2} {e}^{j {φ}_{( M - 1 )}^{t 2}}\end{matrix} ] \cdot [ \begin{matrix}{e}^{j \frac{π}{2}} \\ {e}^{j \frac{π}{2}} \\ ⋮ \\ {e}^{j \frac{π}{2}}\end{matrix} ] = [ \begin{matrix}{a}_{0}^{t 2} {e}^{j ( {φ}_{0}^{t 2} + \frac{π}{2} )} \\ {a}_{1}^{t 2} {e}^{j ( {φ}_{1}^{t 2} + \frac{π}{2} )} \\ ⋮ \\ {a}_{( M - 1 )}^{t 2} {e}^{j ( {φ}_{( M - 1 )}^{t 2} + \frac{π}{2} )}\end{matrix} ] , \\ [ \begin{matrix}{W}_{0}^{r 1} \\ {W}_{1}^{r 1} \\ ⋮ \\ {W}_{( N - 1 )}^{r 1}\end{matrix} ] = [ \begin{matrix}{a}_{0}^{r 1} {e}^{j {φ}_{0}^{r 1}} \\ {a}_{1}^{r 1} {e}^{j {φ}_{1}^{r 1}} \\ ⋮ \\ {a}_{( N - 1 )}^{r 1} {e}^{j {φ}_{( N - 1 )}^{r 1}}\end{matrix} ] \\ [ \begin{matrix}{W}_{0}^{r 2} \\ {W}_{1}^{r 2} \\ ⋮ \\ {W}_{( N - 1 )}^{r 2}\end{matrix} ] = [ \begin{matrix}{a}_{0}^{r 2} {e}^{j {φ}_{0}^{r 2}} \\ {a}_{1}^{r 2} {e}^{j {φ}_{1}^{r 2}} \\ ⋮ \\ {a}_{( N - 1 )}^{r 2} {e}^{j {φ}_{( N - 1 )}^{r 2}}\end{matrix} ] ; \\ [ \begin{matrix}{\overline{W}}_{0}^{r 1} \\ {\overline{W}}_{1}^{r 1} \\ ⋮ \\ {\overline{W}}_{( N - 1 )}^{r 1}\end{matrix} ] = [ \begin{matrix}{a}_{0}^{r 1} {e}^{j {φ}_{0}^{r 1}} \\ {a}_{1}^{r 1} {e}^{j {φ}_{1}^{r 1}} \\ ⋮ \\ {a}_{( N - 1 )}^{r 1} {e}^{j {φ}_{( N - 1 )}^{r 1}}\end{matrix} ] \cdot [ \begin{matrix}{e}^{j \frac{π}{2}} \\ {e}^{j \frac{π}{2}} \\ ⋮ \\ {e}^{j \frac{π}{2}}\end{matrix} ] = [ \begin{matrix}{a}_{0}^{r 1} {e}^{j ( {φ}_{0}^{r 1} + \frac{π}{2} )} \\ {a}_{1}^{r 1} {e}^{j ( {φ}_{1}^{r 1} + \frac{π}{2} )} \\ ⋮ \\ {a}_{( N - 1 )}^{r 1} {e}^{j ( {φ}_{( N - 1 )}^{r 1} + \frac{π}{2} )}\end{matrix} ] ;$$
$$and \\ [ \begin{matrix}{\overline{W}}_{0}^{r 2} \\ {\overline{W}}_{1}^{r 2} \\ ⋮ \\ {\overline{W}}_{( N - 1 )}^{r 2}\end{matrix} ] = [ \begin{matrix}{a}_{0}^{r 2} {e}^{j {φ}_{0}^{r 2}} \\ {a}_{1}^{r 2} {e}^{j {φ}_{1}^{r 2}} \\ ⋮ \\ {a}_{( N - 1 )}^{r 2} {e}^{j {φ}_{( N - 1 )}^{r 2}}\end{matrix} ] \cdot [ \begin{matrix}1 \\ 1 \\ ⋮ \\ 1\end{matrix} ] = [ \begin{matrix}{a}_{0}^{r 2} {e}^{{jφ}_{0}^{r 2}} \\ {a}_{1}^{r 2} {e}^{{jφ}_{1}^{r 2}} \\ ⋮ \\ {a}_{( N - 1 )}^{r 2} {e}^{{jφ}_{( N - 1 )}^{r 2}}\end{matrix} ] \\ [ \begin{matrix}{\overline{W}}_{0}^{r 1} \\ {\overline{W}}_{1}^{r 1} \\ ⋮ \\ {\overline{W}}_{( N - 1 )}^{r 1}\end{matrix} ] = [ \begin{matrix}{a}_{0}^{r 1} {e}^{j {φ}_{0}^{r 1}} \\ {a}_{1}^{r 1} {e}^{j {φ}_{1}^{r 1}} \\ ⋮ \\ {a}_{( N - 1 )}^{r 1} {e}^{j {φ}_{( N - 1 )}^{r 1}}\end{matrix} ] \cdot [ \begin{matrix}1 \\ 1 \\ ⋮ \\ 1\end{matrix} ] = [ \begin{matrix}{a}_{0}^{r 1} {e}^{{jφ}_{0}^{r 1}} \\ {a}_{1}^{r 1} {e}^{{jφ}_{1}^{r 1}} \\ ⋮ \\ {a}_{( N - 1 )}^{r 1} {e}^{{jφ}_{( N - 1 )}^{r 1}}\end{matrix} ] \\ [ \begin{matrix}{\overline{W}}_{0}^{r 2} \\ {\overline{W}}_{1}^{r 2} \\ ⋮ \\ {\overline{W}}_{( N - 1 )}^{r 2}\end{matrix} ] = [ \begin{matrix}{a}_{0}^{r 2} {e}^{j {φ}_{0}^{r 2}} \\ {a}_{1}^{r 2} {e}^{j {φ}_{1}^{r 2}} \\ ⋮ \\ {a}_{( N - 1 )}^{r 2} {e}^{j {φ}_{( N - 1 )}^{r 2}}\end{matrix} ] \cdot [ \begin{matrix}{e}^{j \frac{π}{2}} \\ {e}^{j \frac{π}{2}} \\ ⋮ \\ {e}^{j \frac{π}{2}}\end{matrix} ] = [ \begin{matrix}{a}_{0}^{r 2} {e}^{j ( {φ}_{0}^{r 2} + \frac{π}{2} )} \\ {a}_{1}^{r 2} {e}^{j ( {φ}_{1}^{r 2} + \frac{π}{2} )} \\ ⋮ \\ {a}_{( N - 1 )}^{r 2} {e}^{j ( {φ}_{( N - 1 )}^{r 2} + \frac{π}{2} )}\end{matrix} ] ,$$
wherein W₀^{t1}-W_{(M-1)}^{t1} and W₀^{t2}-W_{(M-1)}^{t2} represent a first set of beamforming weights in which a represents the amplitude component of the weight while φ represents the phase component of the beamforming weight, and where W̅₀^{t1}- W̅_{(M-1)}^{t1} and W̅₀^{t2}- W̅_{(M-1)}^{t2} represent new weights applied to respective cross-polarized antenna within the antenna array and wherein W₀^{r1}-W_{(N-1)}^{r1} and W₀^{r2}-W_{(N-1)}^{r2} represent a first set of beamforming weights in which a represents the amplitude component of the weight while φ represents the phase component of the beamforming weight, and where W̅₀^{r1}- W̅_{(N-1)}^{r1} and W̅₀^{r2}- W̅_{(N-1)}^{r2} represent new weights applied to respective cross-polarized antenna within the antenna array, and wherein M represents a number of transmit antenna in the antenna array and N represents a number of receive antenna in the antenna array.

26. The method as set forth in claim 17, wherein a polarization of at least one of a transmitter and a receiver is determined by hardware.

27. The method as set forth in claim 17, wherein a transmission line of at least one of the transmitter and the receiver comprises an addition λ/4 in a transmission line to one antenna.
